(19) United States
(12) Patent Application Publication
(10) Pub. No.: US 2006/0193664 A1
(43) Pub. Date: Aug. 31, 2006

(54) Original transporting apparatus

(75) Inventor: Takashi Kurokawa, Osaka (JP)

Correspondence Address: SMITH, GAMBRELL & RUSSELL, LLP, 1850 M STREET, N.W., SUITE 800, WASHINGTON, DC, 20036, US

(73) Assignee: KYOCERA MITA CORPORATION

(21) Appl. No.: 11/357,954

(22) Filed: Feb. 22, 2006

(30) Foreign Application Priority Data
Feb. 25, 2005 (JP) 2005-050089

(51) Int. Cl. G03G 15/00

(52) U.S. Cl. 399/365

(57) ABSTRACT

An original transporting apparatus 10 is comprised of an original setting section 11 equipped with an original guide 11a that regulates originals in the width direction, a first transporting mechanism 12 that picks up an original placed on the original setting section 11 under the pressurized state, and a second transporting mechanism 13 that transports the original picked up by the first transporting mechanism 12 to the subsequent stage, and has a pressurization control mechanism that releases the pressurized state of the originals by the first transporting mechanism 12 after the original picked up by the first transporting mechanism 12 reaches the second transporting mechanism 13.

### BACKGROUND OF THE INVENTION

1. Field of the Invention

The present invention relates to an original transporting apparatus comprised of an original setting section equipped with an original guide that regulates originals in the width direction, a first transporting mechanism that picks up originals placed on the original setting section under a pressurized state, and a second transporting mechanism that transports the original picked up by the first transporting mechanism to the subsequent stage.

2. Description of the Related Art

In the event that a plurality of originals are placed on the original setting section equipped with the original guide that regulates originals in the width direction and that the originals with shorter width than the original width regulated by the original guide are mixed in the originals transported by a first transporting mechanism that picks up an original under the pressurized state, continuing the condition in which the short-width originals are fed in company when the preceding original is being transported could lead to change the short-width original position tilted to the transporting direction, and could not only prevent originals from being properly transported but also possibly result in a paper jam.

Therefore, conventionally, in Japanese Unexamined Patent Publication No. 2003-298808, as a mechanism that is intended to separate, transport and read a plurality of originals one by one, an original transporting and reading apparatus equipped with a means for detecting the original guide width, a means for detecting the original width, and a control means to change original transporting conditions or to stop transporting when the size difference between the original guide width and the original width exceeds a specified value was proposed.

In the above-mentioned publication, as an example of changes of the transporting conditions, cases in which a setting to pull back an original (transportation with pull-back) is changed to a setting in which no pull-back is performed (transportation without pull-back), etc. are described. “Original pull-back” which means to transport the original once transported in an opposite direction is a sequence carried out at the time of duplex copying or at the time of transportation to carry out a read operation after detecting the original length. Specifically the sequence is that first an original is transported to detect the original length and is temporarily pulled back, then, is transported again to carry out a read operation. By changing the original transporting conditions, for example, changing transportation with pull-back to transportation without pull-back, a paper jam or oblique transportation can be prevented, breakage of originals can be prevented, and miscopying can be prevented.

However, according to the above conventional technology, it is nothing more than to prevent a paper jam or oblique transportation by stopping the specified transportation sequence, and it is not to carry out a desired operation while avoiding an original paper jam or oblique transportation.

### SUMMARY OF THE INVENTION

It is an object of the present invention to provide an original transporting apparatus that can prevent occurrence of diagonal feed and a paper jam while completing a desired operation for originals in view of the above-mentioned conventional defect.

In order to achieve the above-mentioned object, an original transporting apparatus according to the present invention is comprised of an original setting section equipped with an original guide that regulates originals in the width direction, a first transporting mechanism that picks up an original placed on the original setting section under the pressurized state, and a second transporting mechanism that transports the original picked up by the first transporting mechanism to the subsequent stage, and has a pressurization control mechanism that releases the pressurized state of the originals by the first transporting mechanism after the original picked up by the first transporting mechanism reaches the second transporting mechanism.

The pressurization control mechanism described above is preferably comprised of a distance adjusting mechanism that variably adjusts the relative distance between the original setting table that supports the originals in the original setting section and the first transporting mechanism.

Furthermore, the above-mentioned distance adjusting mechanism is preferably comprised of an elevating mechanism that moves the original setting table vertically with respect to the first transporting mechanism.

### BRIEF DESCRIPTION OF THE DRAWINGS

FIG. 1 is an illustration of an image forming apparatus according to the present invention;

FIG. 2 is an illustration of the image forming apparatus according to the present invention;

FIG. 3 is a block diagram of a control unit of the image forming apparatus according to the present invention; and

FIG. 4 is a control sequence illustration of the image forming apparatus according to the present invention.

### DESCRIPTION OF THE PREFERRED EMBODIMENTS

Referring now to drawings, an original transporting apparatus according to the present invention will be described in detail as follows.

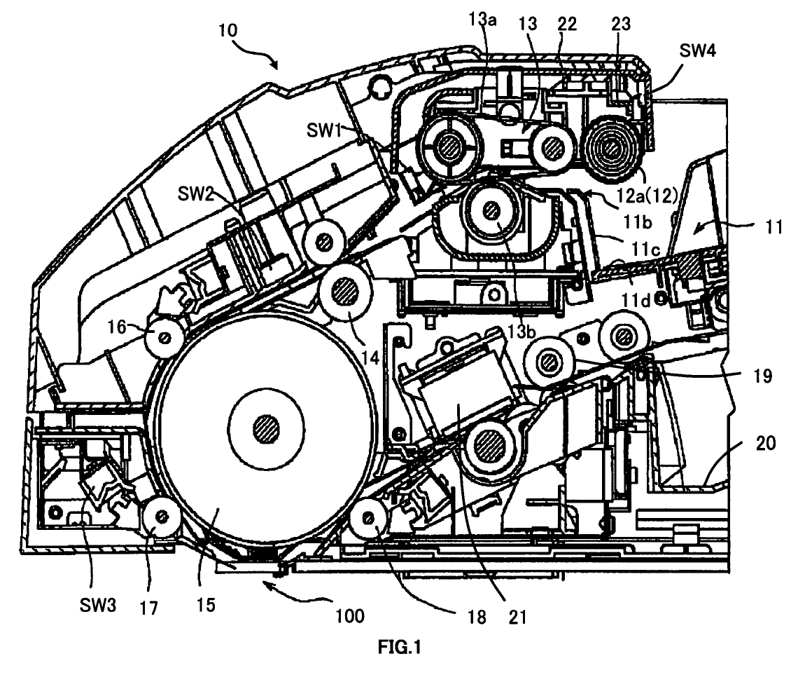

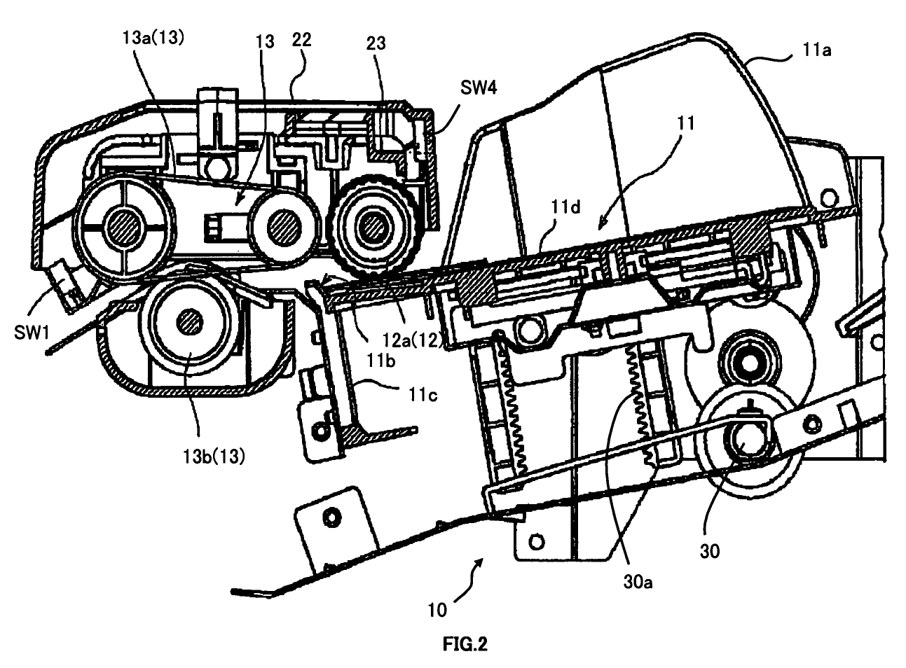

As shown in FIG. 1 and FIG. 2, an original transporting apparatus 10 is comprised of an original setting section 11 equipped with an original guide 11a that regulates originals in the width direction, a first transporting mechanism 12, which is arranged above the head end side of the original setting section 11, and which picks up and transports an original placed on the original setting section 11 under the pressurized state, and a second transporting mechanism 13 that separates and transports the original picked up by the first transporting mechanism 12 one by one to the subsequent stage, wherein the original separated one by one by the second transporting mechanism 13 has the tilt at the original head end straightened by a pair of resist rollers 14, is transported to a read position 100 by a large-diameter transporting roller 15 and small-diameter transporting rollers 16, 17 arranged around it, has the information on the original surface read by a line CCD via an optical system not illustrated, and is discharged onto an original catch tray 20 after having the information on the rear surface of the original transported by discharge rollers 18, 19 read by a contact type line CCD 21.

A pick-up roller 12a that composes the first transporting mechanism 12 is supported by a holder 23 that can make vertically relative moves with respect to a top cover 22. A few pieces of originals discharged overlapped one another from a bundle of originals piled on the original setting section 11 by the pick-up roller 12a are guided upwards after being handled by a form handling section 11c that is located in the discharge path and that has a gradient surface 11b gradually raised on the discharge direction side, reach a flat surface connected to the top end of the gradient surface 11b, and are transported towards the second transporting mechanism 13.

The second transporting mechanism 13 is comprised of a transport belt 13a held to the holder 23 likewise and a roller pad 13b fixed in such a manner as to come in contact with the underside of the transport belt 13a, and in cooperation with a roller pad 13b that rotates in the opposite direction with respect to the transport drive towards the downstream side of an original by the transport belt 13a, and has a few pieces of originals separated one by one and transported.

As shown in FIG. 2, to the original transporting apparatus 10, a tray motor 30 and a gear mechanism 30a driven by the tray motor 30 are equipped, and by the gear mechanism 30a, an original setting table 11d on the bottom surface of the original setting section 11 is moved vertically, and the relative distance from the first transporting mechanism 12 is adjusted in such a manner that the pressurizing force between the original surface and the pick-up roller 12a is included in a specified range in accordance with the load of originals placed on the original setting section 11. That is, a pressurization control mechanism is, at the original setting section 11, a distance adjusting mechanism that variably adjusts the relative distance between the original setting table 11d that supports originals and the first transporting mechanism 12, and that is, the pressurization control mechanism is comprised of an elevating mechanism that moves the original setting table 11d vertically with respect to the first transporting mechanism 12.

The original setting table 11d is driven in the vertical direction between the initial position shown in FIG. 1 and the rise position shown in FIG. 2 by the elevating mechanism, and by this, it is comprised that the pick-up roller 12a and the top surface of the original are adjusted to the specified pressure-contact force.

To be more specific, when a bundle of originals is placed on the original setting table 11d, the originals are detected by an original detection sensor (not illustrated), and the original setting table 11d is driven to ascend until the original located at the uppermost position comes in contact with the pick-up roller 12a.

When the original comes in contact with the pick-up roller 12a, the position of the holder 23 that moves to rise together with the original is detected by a photoelectric upper-limit switch SW4 (hereinafter called the “upper-limit SW”) and the rising motion is stopped. On the other hand, when the original setting table lid descends, the elevating mechanism is stopped by the actuation of an unillustrated lower-limit switch (hereinafter called the “lower-limit SW”).

Even when the originals picked up by the pick-up roller 12a are sent overlapped, the original is separated one by one by the second transporting mechanism 13 and only the top original is transported to the subsequent stage. In such event, since the pressurized state of the original by the first transporting mechanism 12 is comprised to be released by the elevating mechanism, even when an original that follows the next is fed in company when the preceding original is being transported, further transporting force is not applied to the second and after originals, and by this, it is possible to avoid the second and after originals from being diagonally fed by unreasonable transporting force. In particular, even in the event that a plurality of kinds of originals with varying sizes in the width direction are placed on the original setting table 11d and an original narrower than the original guide 11a is located at the second position or after, diagonal feed can be effectively avoided.

A paper feed switch SW1 is installed on the downstream side in the transporting direction of the second transporting mechanism 13 and a resist switch SW2 is installed on the downstream side in the transporting direction of the resist roller 14. In addition, a timing switch SW3 is installed on the upstream side in the transporting direction from the read position 100. When the head end of the original separated by the second transporting mechanism 13 is detected by the paper feed switch SW1, the original is transported for a specified time until the original head end reaches to the pair of standing resist rollers 14 that are stopping, and the second transporting mechanism 13 is stopped in the state with a slight loop formed in the original. By this, the head end of the original is straightened to become perpendicular to the transporting direction. The resist switch SW2 functions as a means to measure the length of the original in the sub-scanning direction. In addition, the timing switch SW3 is installed to detect the read timing of original picture images.

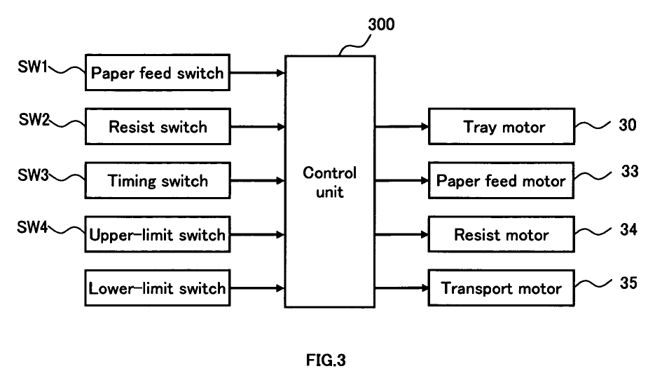

As shown in FIG. 3, a control unit 300 of the original transporting apparatus 10 is comprised of a microcomputer and ROMs that store its control programs, etc., and each piece of detection information of the upper-limit SW4 and the lower-limit SW that detect the location of the original setting table 11d, the paper feed switch SW1, the resist switch SW2, and the timing switch SW3 is inputted, and at the same time, the control unit 300 outputs signals to each of a tray motor 30 that drives the original setting table 11d vertically based on these inputs, a paper feed motor 33 that drives the first and the second transporting mechanisms 12, 13, a resist motor 34 that drives the resist-roller pair 14, and a transport motor 35 that drives the transporting rollers 15, etc. and carries out original transporting control.

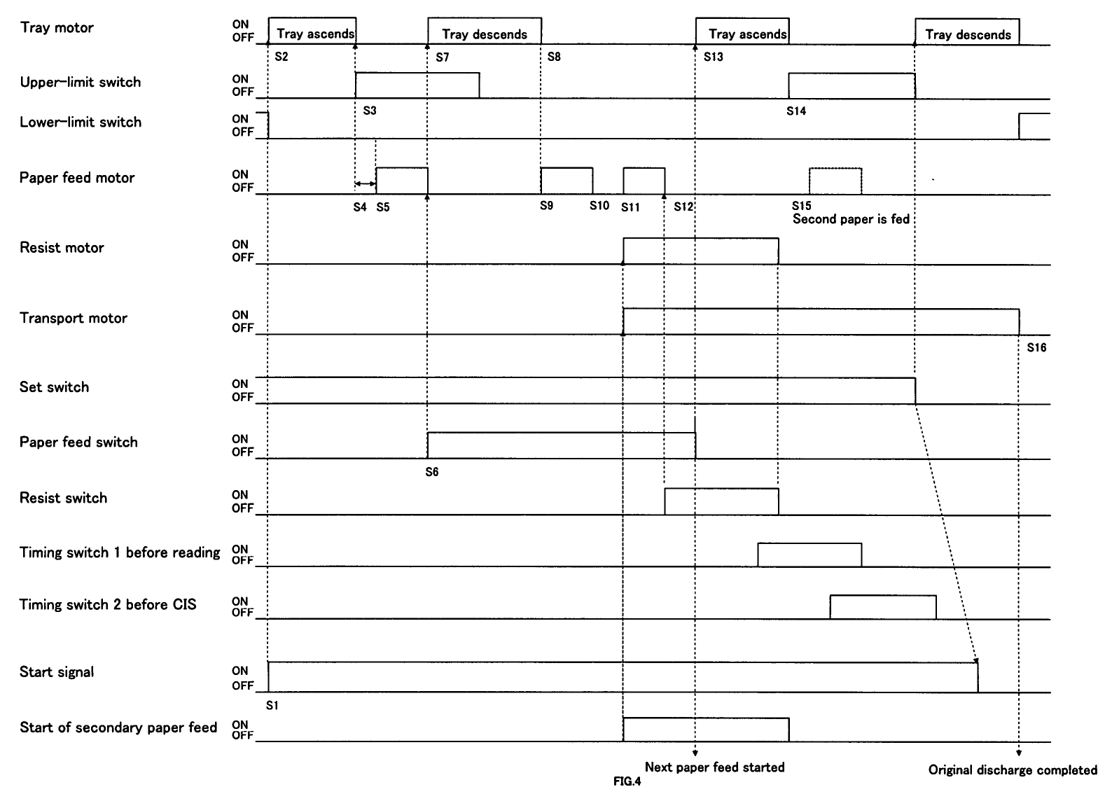

Referring now to FIG. 4, the sequence of each section of the original transporting apparatus 10 will be described. First of all, at the initial position where the original setting table lid descends to the lower limit, setting of originals on the original setting table lid is detected by an original detection sensor then, a start switch on an unillustrated operation panel is turned on (S1), and the tray motor 30 operates and the original setting table lid ascends (S2). The top surface of the original comes in contact with the pick-up roller 12a and the upper limit SW4 operates, and then, ascending of the original setting table lid stops (S3). In a specified time after ascending of the original setting table lid stops, the paper feed motor 33 operates and the original is picked up, and while being separated one by one by the second transporting mechanism 13, the original is transported (S4, S5).

When the arrival of an original at the paper feed switch SW1 is detected, the paper feed motor 33 temporarily stops, the tray motor 30 operates, and the original setting table 11d descends (S6, S7). By the descent of the original setting table lid, the pressurizing force applied to the original is released and the transporting force applied to the second and after originals that are fed together by frictional force with the first original fed by the first transporting mechanism 12 is removed, and diagonal feed by unstable transporting force can be avoided. When the original setting table 11d is detected by the lower-limit SW, the paper feed motor 33 operates again for a specified time (S8, S9), the original reaches the resist roller 14, and the second transporting mechanism 13 stops after the original being transported is allowed to slack off to a specified volume to form a loop. By this operation, the head end is straightened so that the original is transported in the proper direction (S10).

The paper feed motor 33, the resist motor 34, and the transport motor 35 operate at a specified timing that enables CCD to read the original at the reading position 100 (S11), and the paper feed motor 33 transports the tail end of the original as the secondary paper feed assist until the original reaches the resist switch SW2 (S12). Then, when the paper feed SW1 turns off, the tray motor 30 operates to start feeding the next original and the original setting table lid ascends (S13). When the upper-limit SW4 turns on, the tray motor 30 stops and the ascent of the original setting table 11d stops (S14). After a specified time, the paper feed motor 33 operates, the following original feed begins, and in the same sequence, the next original is transported (S15). When the transport motor 35 turns off, transportation of the first original is completed, and the original is discharged onto the original catch tray 19 (S16).

In this way, even when originals with shorter width than the original width regulated by an original guide are mixed, the originals are separated and transported one by one and the original setting table is ascended and descended to mitigate the pressure contact force to the next original, and even when the originals shorter than the original guide 11a set are mixed, the original is transported in the tilted state with respect to the transporting direction, and it is possible to prevent occurrence of a paper jam caused by it.

Now another embodiment will be described. In the above-mentioned embodiment, as a means to release the pressurized state of the original transported, a configuration to equip an elevating function to the original setting table 11d and move the original setting table 11d vertically was described, but it may be acceptable to fix the original setting table 11d and to adjust the original contact pressure force by moving the pick-up roller 12a vertically. Furthermore, it may be configured in such a manner that both the original setting table lid and the pick-up roller 12a are relatively moved to adjust the contact pressure force.

What is claimed is:

1. An original transporting apparatus, comprised of:
an original setting section equipped with an original guide that regulates originals in the width direction;
a first transporting mechanism that picks up an original placed on said original setting section under the pressurized state;
a second transporting mechanism that transports the original picked up by said first transporting mechanism to the subsequent stage; and
a pressurization control mechanism that releases the pressurized state of the originals by said first transporting mechanism after the original picked up by said first transporting mechanism reaches said second transporting mechanism.

2. An original transporting apparatus, comprised of:
an original setting section equipped with an original guide that regulates originals in the width direction;
a first transporting mechanism that picks up an original placed on said original setting section under the pressurized state;
a second transporting mechanism that transports the original picked up by said first transporting mechanism to the subsequent stage; and
a pressurization control mechanism that releases the pressurized state of the originals by said first transporting mechanism after the original picked up by said first transporting mechanism reaches said second transporting mechanism,
wherein said pressurization control mechanism is comprised of a distance adjusting mechanism that variably adjusts the relative distance between the original setting table that supports the originals in the original setting section and said first transporting mechanism.

3. The original transporting apparatus according to claim 2,
wherein said distance adjusting mechanism is comprised of an elevating mechanism that moves said original setting table vertically with respect to said first transporting mechanism.
